(19) United States
(12) Patent Application Publication
(10) Pub. No.: US 2021/0031515 A1
(43) Pub. Date: Feb. 4, 2021

(54) Liquid Discharge Head

(71) Applicant: Brother Kogyo Kabushiki Kaisha, Nagoya-shi (JP)

(72) Inventor: Keita Hirai, Nagoya-shi (JP)

(21) Appl. No.: 16/905,447

(22) Filed: Jun. 18, 2020

(30) Foreign Application Priority Data
Aug. 1, 2019 (JP) 2019-141968

(51) Int. Cl. B41J 2/14

(52) U.S. Cl. CPC B41J 2/14201

(57) ABSTRACT

A liquid discharge head includes: a first substrate including a pressure chamber; and a second substrate. The first substrate has a first surface in which a nozzle communicating with the pressure chamber is opened and a second surface positioned at an opposite side of the first surface and in which a communication hole communicating with the pressure chamber is opened. The second substrate is joined to the second surface of the first substrate and has a channel communicating with the pressure chamber via the communication hole. The pressure chamber has a first end in a first direction and a center portion in the first direction. The communication hole communicates with the first end of the pressure chamber, and the first end of the pressure chamber is greater than the center portion of the pressure chamber in length in a second direction which intersects with the first direction.

### CROSS REFERENCE TO RELATED APPLICATION

The present application claims priority from Japanese Patent Application No. 2019-141968 filed on Aug. 1, 2019, the disclosure of which is incorporated herein by reference in its entirety.

### BACKGROUND

### Field of the Invention:

The present disclosure relates to a liquid discharge head configured to discharge liquid from nozzles.

### Description of the Related Art:

There is known a liquid discharge apparatus including nozzles, pressure chambers communicating with the nozzles, and a reservoir communicating with the pressure chambers via ink supply channels. In the liquid discharge apparatus, the reservoir and the ink supply channels are formed in a reservoir forming member, which is different from a channel substrate in which the pressure chambers are formed. Thus, it is not necessary to form the reservoir in the channel substrate, which downsizes the channel substrate.

### SUMMARY

In the above liquid discharge apparatus, the reservoir forming member is joined to the channel substrate, so that the ink supply channels are connected to ink supply holes formed at ends in a longitudinal direction of the pressure chambers. However, in each pressure chamber, the width of the end having the ink supply hole is narrower than the width of a center portion facing a piezoelectric element. Thus, when the reservoir forming member is joined to the channel substrate, it is difficult to perform the position alignment (position adjustment) between the ink supply channels and the ink supply holes. If the positions of the ink supply channels are shifted from the positions of the ink supply holes, ink may leak and a short circuit may occur between traces formed around the ink supply holes.

An object of the present disclosure is to provide a liquid discharge head in which position alignment (position adjustment) between an ink supply channel and an ink supply hole is easily performed when a reservoir member is joined to a pressure chamber plate.

According to an aspect of the present disclosure, there is provided a liquid discharge head, including: a first substrate including a pressure chamber, the first substrate having a first surface in which a nozzle communicating with the pressure chamber is opened and a second surface positioned at an opposite side of the first surface and in which a communication hole communicating with the pressure chamber is opened; and a second substrate joined to the second surface of the first substrate and in which a channel communicating with the pressure chamber via the communication hole is formed, wherein the pressure chamber has a first end on one side in a first direction and a center portion in the first direction, the first direction being along the first surface, the communication hole communicates with the first end of the pressure chamber, and the first end of the pressure chamber is greater than the center portion of the pressure chamber in length in a second direction, which is along the first surface and intersects with the first direction.

In the liquid discharge head according to the aspect of the present disclosure, the channel formed in the second substrate communicates with the first end at the first side in the first direction of the pressure chamber via the communication hole. Here, the first end of the pressure chamber is greater than the center portion of the pressure chamber in length in the second direction. Thus, the position alignment between the channel and the communication hole is easy when the second substrate having the channel is joined to the first substrate having the pressure chamber.

### BRIEF DESCRIPTION OF THE DRAWINGS

FIG. 1 is a plan view of a printer according to an embodiment of the present disclosure.

FIG. 2 is a plan view of a head in the printer.

FIG. 3 is a cross-sectional view of the head taken along line III-III of FIG. 2.

FIG. 4 is an enlarged view of an area IV depicted in FIG. 2.

FIG. 5 is an enlarged view of the head according to a modified example of the present disclosure, which corresponds to FIG. 4.

FIG. 6 is a cross-sectional view of an end of a pressure chamber according to the modified example of the present disclosure when seen from a conveyance direction.

### DESCRIPTION OF THE EMBODIMENTS

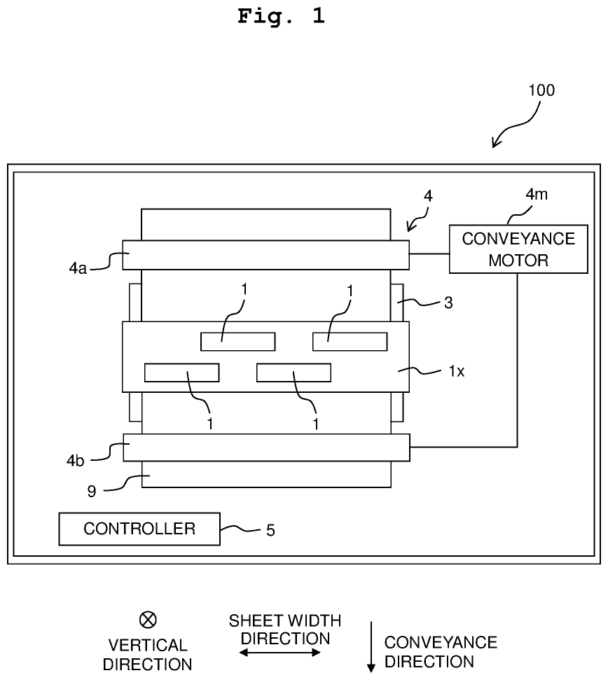

Referring to FIG. 1, a schematic configuration of a printer 100 with heads 1 according to an embodiment of the present disclosure is described below.

The printer 100 includes a head unit 1x including the four heads 1 (an exemplary liquid discharge head), a platen 3, a conveyer 4, and a controller 5.

A sheet 9 is placed on an upper surface of the platen 3.

The conveyer 4 includes two roller pairs 4a and 4b. When a conveyance motor 4m is driven by the control of the controller 5, the roller pairs 4a and 4b rotate with the sheet 9 nipped therebetween, and the sheet 9 is conveyed in a conveyance direction (an exemplary first direction). The two roller pairs 4a and 4b are arranged to sandwich the platen 3 in the conveyance direction.

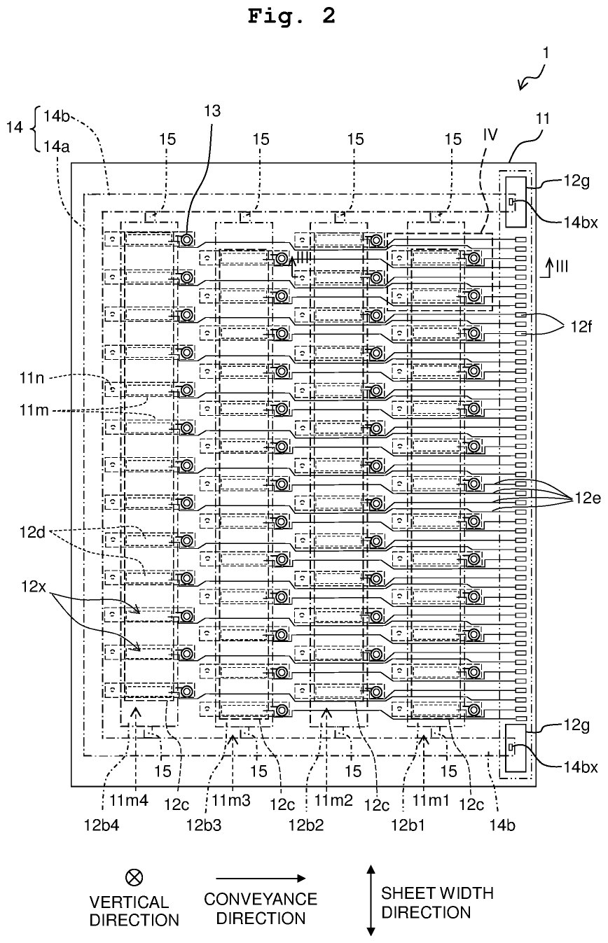

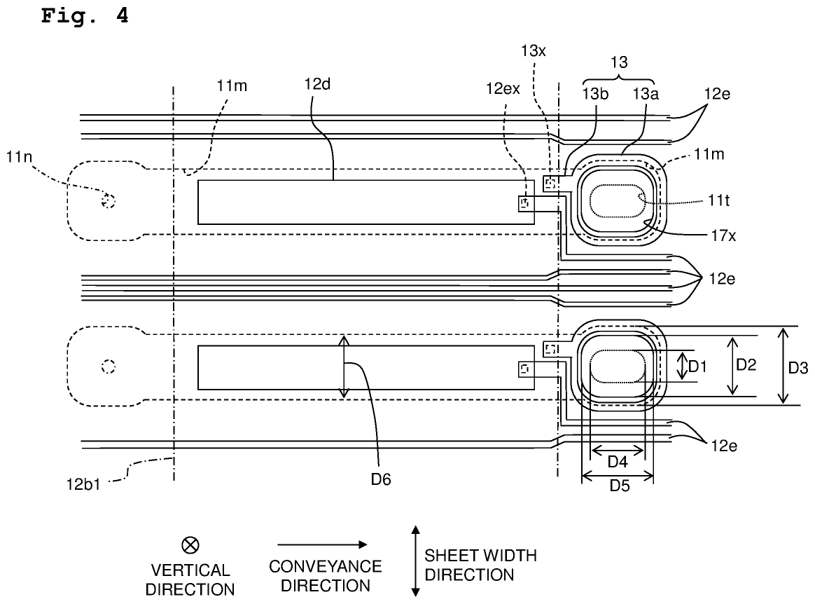

The head unit 1x is a line-type head unit in which ink is discharged from nozzles 11n (see, FIGS. 2 and 4) onto the sheet 9 in a state where the head unit 1x is fixed to the printer. The head unit 1x is long in a sheet width direction (an exemplary second direction). The four heads 1 are arranged zigzag in the sheet width direction.

Here, the sheet width direction is orthogonal to the conveyance direction in this embodiment. Both the sheet width direction and the conveyance direction are orthogonal to a vertical direction.

The controller 5 includes a Read Only Memory (ROM), a Random Access Memory (RAM), and an Application Specific Integrated Circuit (ASIC). The ASIC executes a recording process and the like in accordance with programs stored in the ROM. In the recording process, the controller 5 controls a driver IC 19 (see FIG. 4) and a conveying motor (not depicted) of each head 1 based on a recording instruction (including image data) inputted from an external apparatus such as a personal computer, thus recording an image on the sheet P. Specifically, the controller 5 alternately performs a discharge operation and a conveyance operation. In the discharge operation, ink droplets are discharged from the nozzles 11n. In the conveyance operation, the sheet 9 is conveyed in the conveyance direction by a predefined amount by use of the roller pairs 4a and 4b.

Referring to FIGS. 2 to 4, a configuration of the heads 1 is described below.

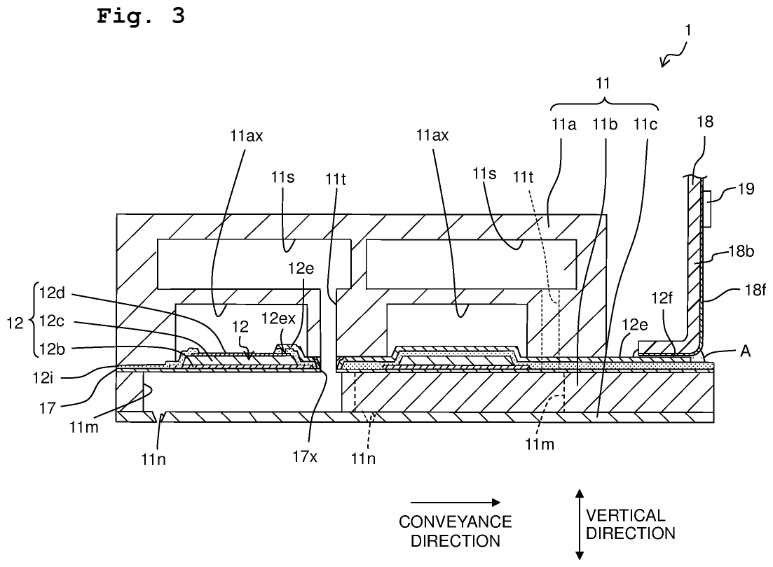

As depicted in FIGS. 2 and 3, each head 1 includes a channel substrate 11, a piezoelectric actuator 12, and a COF 18.

As depicted in FIG. 3, the channel substrate 11 includes a reservoir member 11a, a pressure chamber plate 11b, and a nozzle plate 11c. In FIG. 2, illustration of the reservoir member 11a is omitted.

Pressure chambers 11m are formed in the pressure chamber plate 11b. The nozzle plate 11c is formed with the nozzles 11n that communicate with the respective pressure chambers 11m. Reservoirs 11s are formed in the reservoir member 11a. Each of the reservoirs 11s is common to the pressure chambers 11m. The reservoirs 11s communicate with a tank (not depicted) containing ink.

As depicted in FIG. 2, the pressure chambers 11m are arranged in the sheet width direction to form four pressure chamber rows 11m1 to 11m4 arranged in the conveyance direction. In each of the pressure chamber rows 11m1 to 11m4, the pressure chambers 11m are arranged at regular intervals in the sheet width direction. Of the four pressure chamber rows 11m1 to 11m4, the pressure chambers 11m belonging to the two pressure chamber rows 11m1 and 11m2 disposed on the right of FIG. 2 are arranged zigzag, so that positions in the sheet width direction of the pressure chambers 11m belonging to one of the two pressure chamber rows 11m1 and 11m2 are different from those belonging to the other. Of the four the pressure chamber rows 11m1 to 11m4, the pressure chambers 11m belonging to the two pressure chamber rows 11m3 and 11m4 disposed on the left of FIG. 2 are arranged zigzag, so that positions in the sheet width direction of the pressure chambers 11m belonging to one of the two pressure chamber rows 11m3 and 11m4 are different from those belonging to the other.

As depicted in FIG. 2, the nozzles 11n are arranged in the sheet width direction similarly to the pressure chambers 11m. The nozzles 11n form four nozzle rows arranged in the conveyance direction. In each nozzle row, the nozzles 11n are arranged in the sheet width direction at regular intervals. Of the four nozzle rows, the nozzles 11n belonging to the two nozzle rows disposed on the right of FIG. 2 are arranged zigzag, so that positions in the sheet width direction of the nozzles 11n belonging to one of the two right nozzle rows are different from those belonging to the other. Of the four nozzle rows, the nozzles 11n belonging to the two nozzle rows disposed on the left of FIG. 2 are arranged zigzag, so that positions in the sheet width direction of the nozzles 11n belonging to one of the two left nozzle rows are different from those belonging to the other. The respective nozzles 11n overlap in the vertical direction with ends at an upstream side in the conveyance direction (left side in FIG. 2) of the pressure chambers 11m corresponding thereto.

As depicted in FIG. 3, the nozzle plate 11c is adhered or bonded to a lower surface of the pressure chamber plate 11b. Namely, the nozzle plate 11c is disposed at a side opposite to the piezoelectric actuator 12 with respect to the pressure chamber plate 11b. A lower surface of the nozzle plate is an exemplary first surface of the present disclosure.

The reservoir member 11a is adhered or bonded to an upper surface of the pressure chamber plate 11b via the piezoelectric actuator 12.

Not only the reservoirs 11s but also supply channels lit are formed in the reservoir member 11a. The supply channels lit allow the respective reservoirs 11s to communicate with the pressure chambers 11m. Further, the reservoir member 11a is formed with four recesses 11ax extending in the sheet width direction. The four recesses 11ax are formed in a lower surface of the reservoir member 11a to face the respective pressure chamber rows 11m1 to 11m4 in the vertical direction. Each of the supply channels 11t is an exemplary channel of the present disclosure.

A vibration plate 17 is provided on the upper surface of the pressure chamber plate 11b. The pressure chamber plate 11b is formed by a silicon single crystal substrate, and the vibration plate 17 is, for example, an insulating layer formed by oxidizing or nitriding a surface of the pressure chamber plate 11b. The vibration plate 17 is disposed to cover a substantially entire portion of the upper surface of the pressure chamber plate 11b. The vibration plate 17 is positioned between the piezoelectric actuator 12 and the pressure chamber plate 11b to cover the pressure chambers 11m. An upper surface of the vibration plate 17 is an exemplary second surface of the present disclosure. A combination of the nozzle plate 11c, the pressure chamber plate 11b, and the vibration plate 17 is an exemplary first substrate of the present disclosure.

Portions of the vibration plate 17 facing the respective supply channels 11t in the vertical direction are formed with communication holes 17x. Driving a pump (not depicted) supplies ink from the tank to the reservoirs 11s. The supplied ink passes through the supply channels 11t and the communication holes 17x and then is supplied to the corresponding pressure chambers 11m.

As depicted in FIG. 3, the piezoelectric actuator 12 is disposed on the upper surface of the pressure chamber plate 11b via the vibration plate 17 to cover all the pressure chambers 11m formed in the pressure chamber plate 11b.

In the piezoelectric actuator 12, the common electrode 12b, four piezoelectric bodies 12c, and the individual electrodes 12d are stacked in this order from the bottom.

The common electrode 12b is disposed on the upper surface of the vibration plate 17.

As depicted in FIG. 2, the common electrode 12b includes four common electrodes 12b1 to 12b4 separated from each other in the conveyance direction. Each of the common electrodes 12b1 to 12b4 is common to the pressure chambers 11m belonging to one of the pressure chamber rows 11m1 to 11m4. Each of the common electrodes 12b1 to 12b4 faces the pressure chambers 11m belonging to one of the pressure chamber rows 11m1 to 11m4 in the vertical direction. The common electrodes 12b1 to 12b4 are made from, for example, platinum (Pt).

As depicted in FIG. 2, each of the four the piezoelectric bodies 12c extends in the sheet width direction on an upper surface of one of the common electrodes 12b1 to 12b4, covering all the pressure chambers 11m belonging to one of the pressure chamber rows 11m1 to 11m4. Each piezoelectric body 12c is made from, for example, lead zirconate titanate (PZT).

The individual electrodes 12d are disposed on upper surfaces of the piezoelectric bodies 12c to face the respective pressure chambers 11m in the vertical direction.

As depicted in FIG. 2, the individual electrodes 12d are arranged in the sheet width direction similarly to the pressure chambers 11m. The individual electrodes 12d form four individual electrode rows arranged in the conveyance direction. The individual electrodes 12d belonging to each of the individual electrode rows face one of the common electrodes 12b1 to 12b4 in the vertical direction. In each individual electrode row, the individual electrodes 12d are arranged in the sheet width direction at intervals. The individual electrodes 12d belonging to the two individual electrode rows disposed on the right of FIG. 2 among the four individual electrode rows are arranged zigzag so that positions in the sheet width direction of the individual electrodes 12d belonging to one of the two individual electrode rows are different from those belonging to the other. The individual electrodes 12d belonging to the two individual electrode rows disposed on the left of FIG. 2 among the four individual electrode rows are arranged zigzag so that positions in the sheet width direction of the individual electrodes 12d belonging to one of the two individual electrode rows are different from those belonging to the other.

The individual electrode 12d, the common electrode 12b, and a portion (hereinafter referred to as an active portion) of the piezoelectric body 12c sandwiched between the individual electrode 12d and the common electrode 12b function as a piezoelectric element 12x that is deformable in response to the application of voltage to the individual electrode 12d. Namely, the piezoelectric actuator 12 is formed by piezoelectric elements 12x facing the respective pressure chambers 11m. When the piezoelectric element 12x is driven (e.g., the piezoelectric body 12c is deformed to be convex toward the pressure chamber 11m) in response to the application of the voltage to the individual electrode 12d, the volume of the piezoelectric body 12c is changed to apply pressure to the ink in the pressure chamber 11m. This discharges ink from the nozzle 11n.

Further, the piezoelectric actuator 12 has individual traces 12e, individual contacts 12f, two common contacts 12g, annular traces 13, a common trace 14 and coupling traces 15. The traces 12e, 13 to 15 and the contacts 12f and 12g are made from the same material (e.g., aluminium (Al)).

The individual traces 12e are provided for the respective individual electrodes 12d. The individual traces 12e connect the individual electrodes 12d and the individual contacts 12f corresponding thereto. Each annular trace 13 is connected to any of the common electrodes 12b1 to 12b4. The common electrodes 12b1 to 12b4 are connected to the common trace 14 via the coupling traces 15. Further, the common trace 14 is connected to two common contacts 12g.

As depicted in FIG. 3, the individual contacts 12f are disposed in an area of the pressure chamber plate 11b not covered with the reservoir member 11a. Similarly, the two common contacts 12g are disposed in the area of the pressure chamber plate 11b not covered with the reservoir member 11a.

The individual contacts 12f and two common contacts 12g are arranged in a row in the sheet width direction at a downstream side in the conveyance direction (right side in FIG. 2) with respect to a group formed by all the individual electrodes 12d provided in the piezoelectric actuator 12. The individual contacts 12f are arranged in the sheet width direction at intervals. The two common contact points 12g sandwich the individual contacts 12f in the sheet width direction.

The common trace 14 includes a facing portion 14a and two connecting portions 14b. The facing portion 14a is provided on the upstream side in the conveyance direction (left side in FIG. 2) with respect to the group formed by all the individual electrodes 12d provided in the piezoelectric actuator 12. The two connecting portions 14b extend from both sides in the sheet width direction of the facing portion 14a (in this embodiment, both ends in the sheet width direction of the facing portion 14a) toward the downstream side in the conveyance direction (right side in FIG. 2). The two connecting portions 14b are connected to the two respective common contacts 12g. The facing portion 14a is integrally formed with the two connecting portions 14b. The group of individual electrodes 12d is surrounded by the common trace 14 and the row of the individual contacts 12f.

The facing portion 14a has a rectangular shape that is long in the sheet width direction. Each connecting portion 14b has a rectangular shape that is long in the conveyance direction. An end at the upstream side in the conveyance direction (left side in FIG. 2) of each connecting portion 14b is connected to the facing portion 14a. An end at the downstream side in the conveyance direction (right side in FIG. 2) of each connecting portion 14b is electrically connected to each common contact 12g via a portion (contact portion 14bx) that enters into a through hole of an insulating film 12i described below. Each connecting portion 14b is connected to the common electrodes 12b1 to 12b4 through the connecting traces 15.

The common trace 14 and the coupling traces 15 are larger in width than the traces 12e and 13. The traces 12e and 13-15 have the substantially same thickness.

The individual traces 12e extend in the conveyance direction. An end at the upstream side in the conveyance direction (left side in FIG. 2) of each individual trace 12e has a contact portion 12ex (see FIG. 3) with the corresponding individual electrode 12d. An end at the second side in the conveyance direction (right side in FIG. 2) of each individual trace 12e has an individual contact 12f.

The individual traces 12e that are connected to individual electrodes 12d (included in the individual electrodes 12d forming the individual electrode row at the most upstream side in the conveyance direction, and except for the individual electrodes 12d positioned at the both ends in the sheet width direction) extend in the conveyance direction and pass through between the two individual electrodes 12d adjacent to each other in the sheet width direction in the second, third, and fourth individual electrode rows from the upstream side in the conveyance direction. The individual traces 12e that are connected to individual electrodes 12d (included in the individual electrodes 12d forming the second individual electrode row from the upstream side in the conveyance direction, and except for the individual electrode 12d positioned at one side in the sheet width direction (lower side in FIG. 2)) extend in the conveyance direction and pass through between the two individual electrodes 12d adjacent to each other in the sheet width direction in the third and fourth individual electrode rows from the upstream side in the conveyance direction. The individual traces 12e that are connected to individual electrodes 12d (included in the individual electrodes 12d forming the third individual electrode row from the upstream side in the conveyance direction, and except for the individual electrode 12d positioned at another side in the sheet width direction (upper side in FIG. 2)) extend in the conveyance direction and pass through between the two individual electrodes 12d adjacent to each other in the sheet width direction in the fourth individual electrode row from the upstream side in the conveyance direction.

As depicted in FIGS. 2 and 4, each annular trace 13 has an annular portion 13a and an extending portion 13b that extends in the conveyance direction from the annular portion 13a. Each annular portion 13a surrounds the communication hole 17x. Each extending portion 13b has a first end connected to the annular portion 13a and a second end connected to the common electrode 12b. In this embodiment, each annular trace 13 is arranged so as not to overlap with a separation wall, which is provided between any two pressure chambers 11m adjacent to each other in the sheet width direction.

In this embodiment, the insulating film 12i (not depicted in FIG. 2; see FIG. 3) is provided to improve the insulating property between each individual trace 12e and the common electrode 12b. The insulating film 12i is disposed over the substantially entire upper surface of the vibration plate 17, and covers the common electrodes 12b1 to 12b4, the piezoelectric bodies 12c, the common trace 14, and the coupling traces 15. However, the insulating film 12i covers only outer edges of the respective individual electrodes 12d so as not to inhibit the driving of the piezoelectric elements 12x, and the center portions of the respective individual electrodes 12d are exposed from the insulating film 12i. The insulating film 12i is made from, for example, silicone dioxide (SiO₂).

The individual traces 12e, the annular traces 13, the individual contacts 12f, and the two common contacts 12g are disposed on an upper surface of the insulating film 12i.

Similar to the common electrode 12b, the common trace 14 and the coupling traces 15 are arranged on the upper surface of the vibration plate 17 at a lower side of the insulating film 12i.

Each of the individual traces 12e is electrically connected to the corresponding one of the individual electrodes 12d through a portion (contact portion 12ex) that enters into the through hole of the insulating film 12i. The extending portion 13b of each annular trace 13 is electrically connected to any of the common electrodes 12b1 to 12b4 via a portion (contact portion 13x) that enters into the through hole of the insulating film 12i.

Each contact portion 12ex is provided at an end on the downstream side in the conveyance direction (right side in FIGS. 2 to 4) of the corresponding one of individual electrodes 12d. Each contact portion 13x is provided at an end on the downstream side in the conveyance direction (right side in FIG. 2) of each of the common electrodes 12b1 to 12b4.

As depicted in FIG. 3, the COF 18 has an insulating sheet 18b made from polyimide or the like, individual traces 18f electrically connected to the respective individual contacts 12f, and two common traces (not depicted) electrically connected to the respective common contacts 12g.

A first end of the COF 18 is adhered or bonded to the channel substrate 11 via an adhesive A with the individual traces 18f and the common traces facing the individual contacts 12f and the common contacts 12g, respectively. The second end of the COF 18 is electrically connected to the controller 5 (see FIG. 1).

The driver IC 19 is mounted between the first end and the second end of the COF 18. The driver IC 19 generates a driving signal to drive the piezoelectric element 12x based on a signal from the controller 5, and provides the driving signal to the individual electrode 12d. The electric potential of the common electrode 12b is maintained at a ground potential. When the driving signal is supplied to the individual electrode 12d, the electric potential of the individual electrode 12d varies between a predetermined driving potential and the ground potential.

When the electric potential of the individual electrode 12d changes from the ground potential to the driving potential, a potential difference is caused between the individual electrode 12d and the common electrode 12b. This causes an electric field parallel to a thickness direction of the piezoelectric body 12c to act on the active portion of the piezoelectric body 12c. At this time, since the polarization direction of the active portion of the piezoelectric body 12c (the thickness direction of the piezoelectric body 12c) is the same as the direction of the electric field, the active portion extends in the thickness direction of the piezoelectric body 12c and contracts in a planar direction of the piezoelectric body 12c. The contraction deformation of the active portion of the piezoelectric body 12c deforms the vibration plate 17 and a portion of the piezoelectric actuator 12 facing the pressure chamber 11m so that the portion becomes convex toward the pressure chamber 11m. This deformation reduces the volume of the pressure chamber 11m, applying the energy to the ink in the pressure chamber 11m and discharging ink droplets from the nozzle 11n communicating with the pressure chamber 11m.

As depicted in FIGS. 2 and 4, each pressure chamber 11m has a substantially rectangular planar shape that is long in the conveyance direction. Then, as depicted in FIG. 4, both ends in the conveyance direction of each pressure chamber 11m has a length D3 in the sheet width direction that is, for example, approximately 3 to 4 μm longer than a length D6 in the sheet width direction of a center portion in the conveyance direction of each pressure chamber 11m. This makes a length D2 in the sheet width direction of the communication hole 17x long, making it possible to easily perform the position alignment between the supply channels 11t and the communication holes 17x when the reservoir member 11a is joined to the pressure chamber plate 11b. Further, a length in the sheet width direction of a center portion in the conveyance direction of the separation wall between two pressure chambers 11m adjacent to each other in the sheet width direction can be longer than a length in the sheet width direction of both ends in the conveyance direction of the separation wall. This inhibits the crosstalk between the two pressure chambers 11m adjacent to each other in the sheet width direction.

As depicted in FIG. 4, since the individual traces 12e are arranged between the two communication holes 17x adjacent to each other in the sheet width direction, the accuracy of position alignment in the sheet width direction between the supply channels 11t and the communication holes 17x is required to be higher than that in the conveyance direction. In this regard, in this embodiment, as depicted in FIG. 4, a length D5 in the conveyance direction of the communication hole 17x is longer than the length D2 in the sheet width direction of the communication hole 17x. A length D4 in the conveyance direction of a cross section parallel to a horizontal plane of the supply channel 11t is longer than the length D1 in the sheet width direction. This makes the accuracy of the position alignment between the supply channels 11t and the communication holes 17x in the sheet width direction higher than that in the conveyance direction. Further, it is possible to inhibit the decrease in channel resistance by making the lengths in the sheet width direction of the communication hole 17x and the cross section parallel to the horizontal plane of the supply channel 11t short and making the length in the conveyance direction of the communication hole 17x and the cross section parallel to the horizontal plane of the supply channel 11t long.

As depicted in FIG. 4, the length D3 in the sheet width direction of an end at the downstream side in the conveyance direction (right side in FIG. 4) of the pressure chamber 11m is longer than the length D2 in the sheet width direction of the communication hole 17x. The length D2 in the sheet width direction of the communication hole 17x is longer than the length D1 in the sheet width direction of the cross section parallel to the horizontal direction of the supply channel 11t. Therefore, it is easy to perform the position alignment when the communication hole 17x is formed at the end at the downstream side in the conveyance direction of each pressure chamber 11m. Further, when the reservoir member 11a is joined to the pressure chamber plate 11b, it is possible to easily perform the position alignment between the supply channels 11t and the communication holes 17x.

Further, as depicted in FIG. 4, the difference between the length D2 in the sheet width direction of the communication hole 17x and the length D1 in the sheet width direction of the cross-section parallel to the horizontal direction of the supply channel 11t is greater than the difference between the length D3 in the sheet width direction of the end at the downstream side in the conveyance direction (right side in FIG. 4) of the pressure chamber 11m and the length D2 in the sheet width direction of the communication hole 17x. Therefore, a shift amount (deviation amount) in the sheet width direction when the reservoir member 11a is joined to the pressure chamber plate 11b is allowed to be larger than an shift amount in the sheet width direction of a mask used when the communication holes 17x are formed at the ends of the respective pressure chambers 11m.

The annular traces 13 surrounding the respective communication holes 17x are formed on the upper surface of the insulating film 12i. Forming the annular traces 13 makes the periphery of the communication holes 17x higher than the upper surface of the insulating film 12i. Thus, even when ink flows out of a joining portion between the supply channel 11t and the communication hole 17x due to, for example, joining failure between the reservoir 11a and the pressure chamber plate 11b, the ink is blocked by the annular trace 13. As a result, the ink flowing out of the joining portion between the supply channel 11t and the pressure chamber 11m is not likely to reach the piezoelectric actuator 12.

Further, as depicted in FIG. 4, at least part of each annular trace 13 extends outward beyond the end at the downstream side in the conveyance direction (right side in FIG. 4) of the pressure chamber 11m, when viewed from above. In other words, at least part of each annular trace 13 overlaps with a part of the pressure chamber plate 11b where the pressure chamber 11m is not formed, when viewed from above. Therefore, when the reservoir member 11a is pressed against and joined to the pressure chamber plate 11b, it is possible to reduce the possibility that the vibration plate 17 is damaged.

Further, as depicted in FIG. 3, part of the reservoir member 11a in which the recess flax and the supply channel 11t are not formed is joined to the periphery of the communication hole 17x in the upper surface of the vibration plate 17. Namely, the end in the conveyance direction of each pressure chamber 11m is constrained or held by the reservoir member 11a. This inhibits the crosstalk between the two pressure chambers 11m adjacent to each other in the sheet width direction.

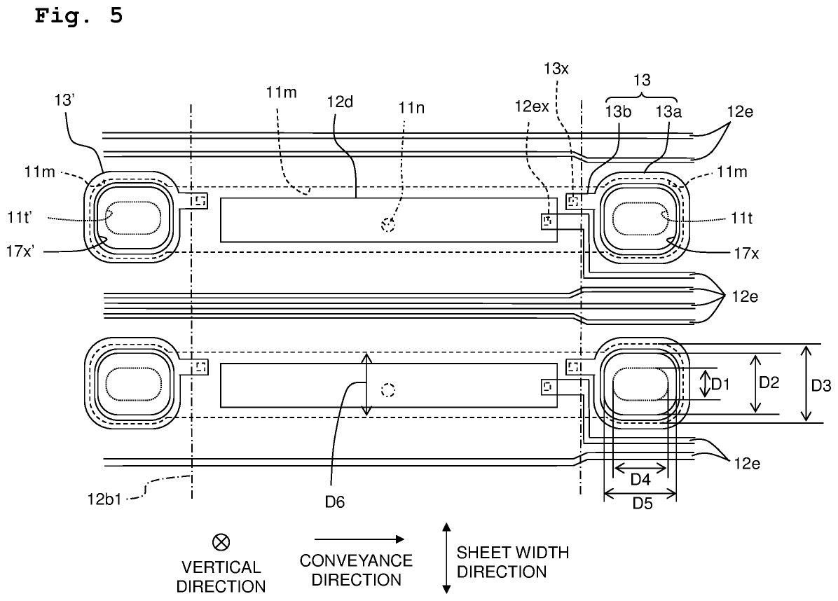

In the above embodiment, only the supply channels 11t for supplying the ink in the reservoir 11s to the pressure chambers 11m are formed in the reservoir member 11a. The present disclosure, however, is not limited thereto. For example, a recovery reservoir and return channels 11t′ for returning the ink in the pressure chambers 11m to the recovery reservoir may be further formed, and ink may circulate between the reservoir 11s and the pressure chambers 11m and the recovery reservoir. In this case, as depicted in FIG. 5, the supply channels 11t may communicate with the ends at the downstream side in the conveyance direction (right side in FIG. 5) of the pressure chambers 11m via the communication holes 17x similarly to the above embodiment. On the other hand, the return channels 11t′ may communicate with the ends at the upstream side in the conveyance direction (left side in FIG. 5) of the pressure chambers 11m via communication holes 17x′. Further, annular traces 13′ may be formed to surround the periphery of the communication holes 17x′. Further, the nozzles 11n may be arranged to overlap with the center portions in the conveyance direction of the pressure chambers.

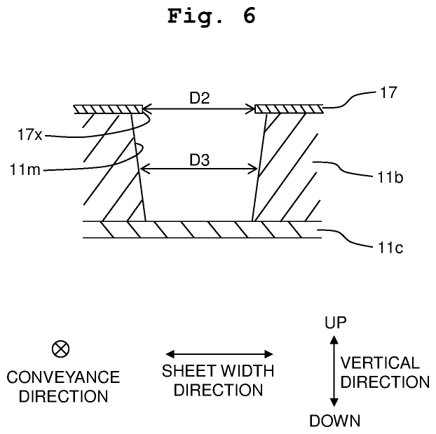

In the above embodiment, the length D3 in the sheet width direction of the end in the conveyance direction of each pressure chamber 11m is constant with respect to the vertical direction. The present disclosure, however, is not limited thereto. For example, as depicted in FIG. 6, the length D3 in the sheet width direction of the end in the conveyance direction of each pressure chamber 11m may increase upwardly. This makes the length D2 in the sheet width direction width of the communication hole 17x larger, making it possible to easily perform the position alignment between the supply channels 11t and the communication holes 17x when the reservoir member 11a is joined to the pressure chamber plate 11b.

In the above embodiment, the communication holes 17x are surrounded by the metallic annular traces 13. The present disclosure, however, is not limited thereto. The communication holes 17x may be surrounded by, for example, annular members made from resin.

In the above embodiment and the modified examples, the printer 100 performs printing on the recording sheet 9 by a line head system in which ink is discharged from the head unit 1x that is fixed to the printer 100 and is long in the sheet width direction. The printer 100, however, may perform printing on the recording sheet 9 by a serial head system in which the carriage moves the ink-jet head in the sheet width direction.

In the embodiment and the modified examples, the examples in which the present disclosure is applied to the ink-jet head that discharges ink from nozzles, are explained. The present disclosure, however, is not limited thereto. The present disclosure is applicable to a liquid discharge apparatus that is different from the ink-jet head and is configured to discharge any other liquid than ink from nozzles.

What is claimed is:

1. A liquid discharge head, comprising:
a first substrate including a pressure chamber, the first substrate having a first surface in which a nozzle communicating with the pressure chamber is opened and a second surface positioned at an opposite side of the first surface and in which a communication hole communicating with the pressure chamber is opened; and
a second substrate joined to the second surface of the first substrate and in which a channel communicating with the pressure chamber via the communication hole is formed,
wherein the pressure chamber has a first end on one side in a first direction and a center portion in the first direction, the first direction being along the first surface, the communication hole communicates with the first end of the pressure chamber, and
the first end of the pressure chamber is greater than the center portion of the pressure chamber in length in a second direction, which is along the first surface and intersects with the first direction.

2. The liquid discharge head according to claim 1, wherein the communication hole has a length in the first direction which is longer than a length in the second direction.

3. The liquid discharge head according to claim 1,
wherein the channel has a cross section parallel to the first surface, and
the cross section has a length in the first direction which is longer than a length in the second direction.

4. The liquid discharge head according to claim 1, wherein the second surface of the first substrate is formed with an annular trace surrounding the communication hole.

5. The liquid discharge head according to claim 4, wherein at least part of the annular trace overlaps with part of the first substrate in which the pressure chamber is not formed, when seen from a direction perpendicular to the first surface.

6. The liquid discharge head according to claim 1, further comprising a piezoelectric element disposed on the second surface of the first substrate and configured to apply discharge energy to liquid in the pressure chamber,
wherein the second substrate has a third surface that faces the second surface of the first substrate,
the third surface has a recess covering the piezoelectric element, and
part of the third surface of the second substrate in which the recess is not formed is joined to a circumference of the communication hole in the second surface of the first substrate.

7. The liquid discharge head according to claim 1,
wherein the pressure chamber has a second end on another side in the first direction,
the nozzle communicates with the second end of the pressure chamber, and
the second end of the pressure chamber is greater than the center portion of the pressure chamber in length in the second direction.

8. The liquid discharge head according to claim 1, wherein the length in the second direction of the first end of the pressure chamber increases in a direction from the first surface toward the second surface.

9. The liquid discharge head according to claim 1,
wherein the channel has a cross section parallel to the first surface,
the communication hole is greater than the cross section of the channel in length in the second direction, and
the first end of the pressure chamber is greater than the communication hole in length in the second direction.

10. The liquid discharge head according to claim 9, wherein a difference between the length in the second direction of the communication hole and the length in the second direction of the cross section of the channel is greater than a difference between the length in the second direction of the first end of the pressure chamber and the length in the second direction of the communication hole.
